(19) United States
(12) Patent Application Publication
(10) Pub. No.: US 2008/0205786 A1
(43) Pub. Date: Aug. 28, 2008

(54) Method and system for filtering images in video coding

(76) Inventors: Zhang Young, Santa Clara, CA (US); Jian Wang, Sunnyvale, CA (US)

Correspondence Address: INNOVATION MANAGEMENT SCIENCES, P. O. BOX 1169, LOS ALTOS, CA, 94023-1169, US

(21) Appl. No.: 11/638,088

(22) Filed: Dec. 13, 2006

(51) Int. Cl. G06K 9/40

(52) U.S. Cl. 382/261

(57) ABSTRACT

A method, system and computer program product for filtering an image is disclosed. The image includes a plurality of pixels. A difference value between a pixel parameter of a pixel and the pixel parameter of one or more neighboring pixels is determined. Each pixel is then classified into a category based on the difference value. A standard deviation value of a Gaussian filter for each pixel is calculated based on the category. A window size for Gaussian filtering the pixel is estimated using the standard deviation value. Each pixel is then filtered using the standard deviation value and the window size.

### RELATED APPLICATION

This application is related to the following application which is hereby incorporated by reference as if set forth in full in this specification: Co-pending U.S. patent application Ser. No. (TBD), entitled ‘Method and System and for Reducing Noise in Images in Video Coding’, filed herewith and bearing attorney docket number WWCl-021-999.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The invention relates generally to the field of video coding. More specifically, the invention relates to noise filtering in video sequences before they enter video encoders.

### BACKGROUND OF THE INVENTION

An image is typically represented by a two-dimensional array of digital values. A digital value of the image is referred to as a picture element or a pixel. Images are created by various devices, such as digital cameras, scanners, coordinate-measuring machines, seismographic profiling and the like. Video coding technology is used for storage and transmission of images. The images are compressed using various compression tools before the transmission. The compression tools are defined by various standards. Examples of international standards include, but are not limited to, MPEG2, H.263, MPEG4 and H.264. H.264 is the latest international video standard. The compression tools of all those standards do not consider the noises, for example, white Gaussian noise, random noise, and salt and pepper noise, introduced in the images. The presence of noise not only degrades the image quality, but also lowers encoding performance. Hence, to improve compression efficiency, removal of noise is desired.

During video compression algorithm, in order to smoothen the compression process, filtering is performed prior to encoding process. Filtering needs to be done in such a way that, while noise is removed, the details and textures in the image should remain visually intact. Existing pre-processing filtering systems include simple low-pass filters, such as mean filter, median filter and Gaussian filter. These pre-processing filtering systems keep the low frequency components of the image and reduce the high frequencies. High frequencies are responsible for producing sharpness of the image. Hence, noise and unnoticeable high frequency signals need to be removed selectively prior to encoding, while local edge segments in the images have to be preserved. Therefore, it is desired to incorporate local statistical features of the images into filtering process to significantly attenuate noise, maintain satisfactory subjective quality, as well as improve coding efficiency.

U.S. Pat. No. 5,764,307 discloses a system for noise reduction in an image using a Gaussian filter kernel. However, the patent filters displaced frame difference (DFD) which is an intermediate product of encoding process. As a result, it requires a modification of video encoders. Hence, the system disclosed cannot be used with current standard encoders.

U.S. Pat. No. 6,922,488 filters image by using a digital image edge detection algorithm. Edge detection is performed by comparing image over pre-stored images. Hence, a large frame buffer containing the pre-stored images is required for filtering of the digital image.

In light of the foregoing discussion, there is a need for a method and system for removing noise, which is part of high frequency signals from digital video using local statistical characteristics and suitable for use with all types of video encoders.

### SUMMARY

An objective of the invention is to provide a filter to remove noises while preserving human eyes sensitive information in an image, and to be used with standardized encoders.

Another objective of the invention is to provide an adaptive method for filtering the image to incorporate local statistical features into filtering process to attenuate noise and improve encoding efficiency.

Yet another objective of the invention is to improve visual quality and save bit-rate for an encoding system.

Still another objective of the invention is to provide a method for Gaussian filtering of the image while preserving boundaries and details in the image.

To achieve the above-mentioned objectives, the invention provides a method, system and computer program product for filtering an image. The image, including a plurality of pixels, is input into a pre-processing filter. A difference value for each of the plurality of pixel is determined. Thereafter, a category for each of the plurality of pixels is determined based on the difference value. Based on the category of each of the plurality of pixels a standard deviation value for a Gaussian filter kernel is determined. Further, window size is determined based on the standard deviation value. Using the standard deviation value and the window size, filtered pixel value is determined. Finally, each of the plurality of pixels is modified based on the filtered pixel value of each of the plurality of pixels.

The system for filtering an image includes a difference value calculator, a pixel classifier, a window size estimator, a standard deviation calculating module and a Gaussian filter. The difference value calculator determines a difference value for each of the plurality of pixels. The pixel classifier then determines a category for each of the plurality of pixels based on the difference value. The standard deviation calculating module determines the standard deviation value based on the category of the pixel. The window size estimator determines window size based on the standard deviation value. The Gaussian filter filters each of the plurality of pixels based on the standard deviation value and window size determined for each of the plurality of pixels.

Various embodiments of the invention provide a method, system and computer program product for filtering an image. The pre-processing filter helps to remove noises and unnoticeable high frequency signals in the images. The method for category determination incorporates local statistical features of the image and thus, helps in significantly attenuating noise and improving encoding efficiency. Further, incorporating local features into the filtering process improves the visual quality and bit-rate saving.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 illustrates an environment in which various embodiments of the invention may be practiced;

FIG. 2 is a block diagram of a pre-processing filter, in accordance with an embodiment of the invention;

FIG. 3 illustrates a neighboring window for classifying a pixel in an image, in accordance with an embodiment of the invention;

FIG. 4 is a flowchart illustrating a method for filtering an image, in accordance with an embodiments of the invention;

FIG. 5 is a flowchart illustrating a method for filtering a pixel in an image, in accordance with an embodiment of the invention; and

FIGS. 6a, 6b and 6c depict a flowchart illustrating an embodiment of the method for filtering a pixel of an image in accordance with an embodiment of the invention.

### DESCRIPTION OF VARIOUS EMBODIMENTS

Various embodiments of the invention provide a method, system and computer program product for filtering an image. One or more images form a video sequence. The image includes a plurality of pixels. Each pixel is classified into a category based on the difference between a pixel parameter value of the pixel and pixel parameter values of one or more neighboring pixels. A standard deviation value is calculated for each pixel based on the category. The standard deviation value is then used to compute a Gaussian filter kernel and a window size for filtering the pixel. A filtered pixel value is determined for each pixel. Filtered pixels are then input in a standardized encoder for further processing.

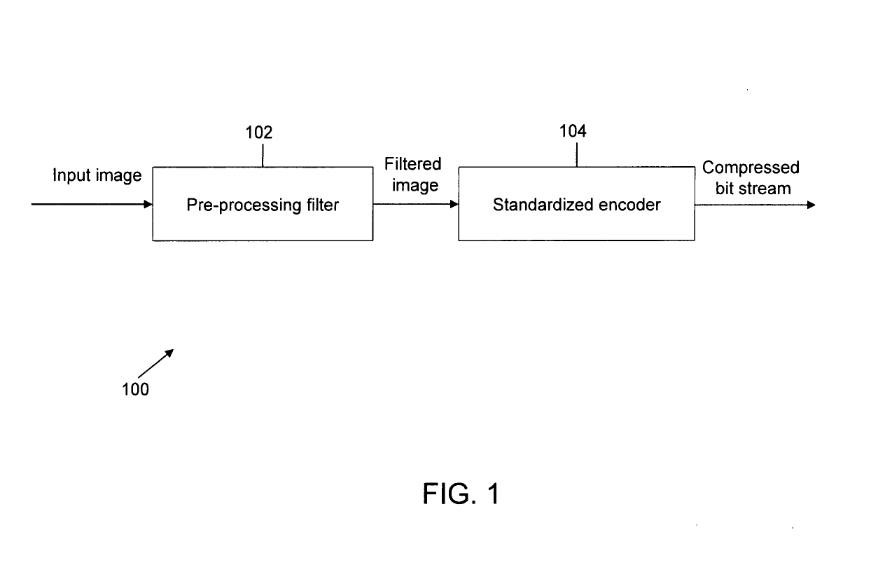

FIG. 1 illustrates an environment 100 in which various embodiments of the invention may be practiced. Environment 100 includes a pre-processing filter 102 and a standardized encoder 104. Pre-processing filter 102 filters an image of a video sequence to produce a filtered image. Filtering the image reduces the noise component in the image thereby improving the video quality and the coding efficiency. An exemplary pre-processing filter has been explained in a commonly owned co-pending U.S. patent application Ser. No. (TBD) entitled ‘Method and system for filtering an image for video coding’, filed herewith. The filtered image is input into a standardized encoder 104 to obtain a compressed bit stream. Standardized encoder 104 encodes the filtered image according to various standards. Examples of standards include video compression standards H.263, H.264, Moving Picture Experts Group standards (MPEG-2 and MPEG-4) and the like.

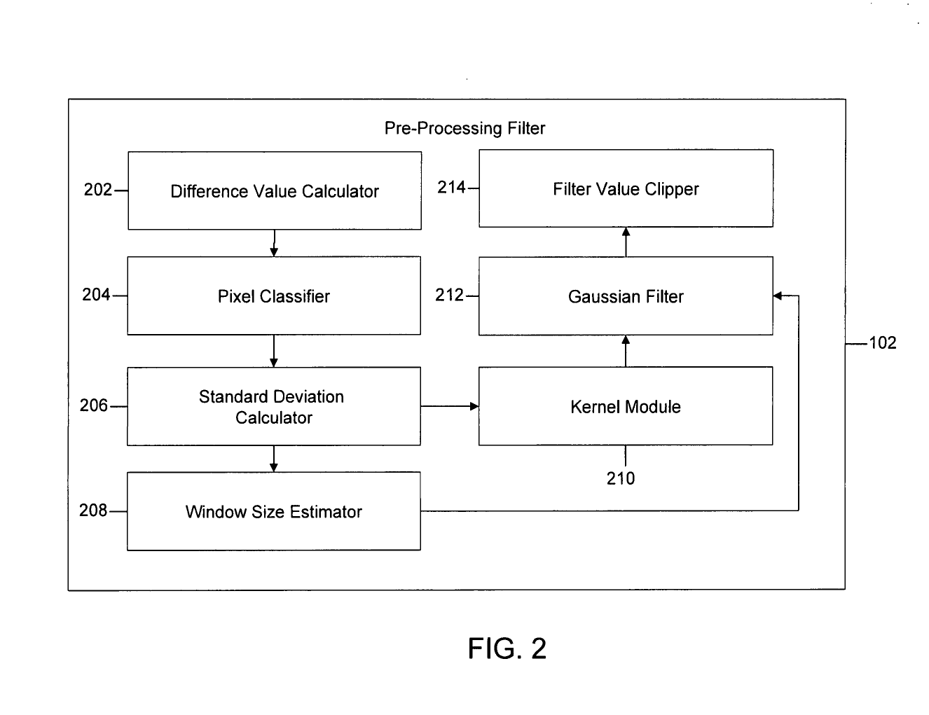

In accordance with the invention, pre-processing filter 102 filters the image by classifying the pixels in a category based on the difference between a pixel parameter value and the pixel parameter values of one or more neighboring pixels. The pixels are then filtered using a Gaussian filter based on the category. Pre-processing filter 102 and its various modules are explained in detail in conjunction with FIG. 2.

FIG. 2 is a block diagram of pre-processing filter 102 in accordance with an embodiment of the invention. Pre-processing filter 102 includes a difference value calculator 202, a pixel classifier 204, a standard deviation calculator 206, a window size estimator 208, a kernel module 210, a Gaussian filter 212, and a filter value clipper 214.

Difference value calculator 202 receives an image including a plurality of pixels. Difference value calculator 202 determines a difference value of a pixel parameter, between each of the plurality of pixels and one or more neighboring pixels corresponding to each of the plurality of pixels. Examples of pixel parameter may include pixel luminance, pixel chrominance and the like. In accordance with an embodiment of the invention, difference value calculator 202 calculates the difference between the pixel luminance and the luminance of one or more neighboring pixels. Difference value calculator 202 provides the one or more difference values to pixel classifier 204. Pixel classifier 204 determines a category for each of the plurality of pixels based on the difference values. For example, a pixel may be classified as a flat, step-wise, noise or edge pixel.

Thereafter, standard deviation calculator 206 calculates a standard deviation value for each pixel of the plurality of pixels based on the category determined by pixel classifier 204. Standard deviation calculator 206 provides the calculated standard deviation value to window size estimator 208. Window size estimator 208 estimates a window size for filtering each of the plurality of pixels based on the calculated standard deviation value.

Subsequently, window size estimator 208 provides the estimated window size to kernel module 210. Kernel module 210 calculates a Gaussian filter kernel for the determined window size based on the standard deviation value. Based on the Gaussian filter kernel and the window size, Gaussian filter 212 generates a filtered pixel value for each of the plurality of pixels. The filtered pixel value is further clipped by filter value clipper 214. Filter value clipper 214 delimits the filtered pixel value between a predetermined minimum pixel parameter and a maximum pixel parameter value. In accordance with an embodiment of the invention, the minimum pixel parameter value may be limited to zero and the maximum pixel parameter value may be limited to 255. A detailed description of a similar filter value clipper is provided in a commonly owned co-pending U.S. patent application Ser. No. (TBD) entitled ‘Method and System for Filtering an Image in a Video Coding System’, which is filed herewith.

In an embodiment of the invention, the filtering of each of the plurality of pixels and the categorization of the remaining pixels is performed in parallel by pre-processing filter 102.

In accordance with various embodiments of the invention modules of pre-processing filter 102 such as difference value calculator 202, pixel classifier 204, standard deviation calculator 206, window size estimator 208, kernel module 210, Gaussian filter 212 and filter value clipper 214 may be implemented as a hardware module, software module, firmware module or a combination thereof.

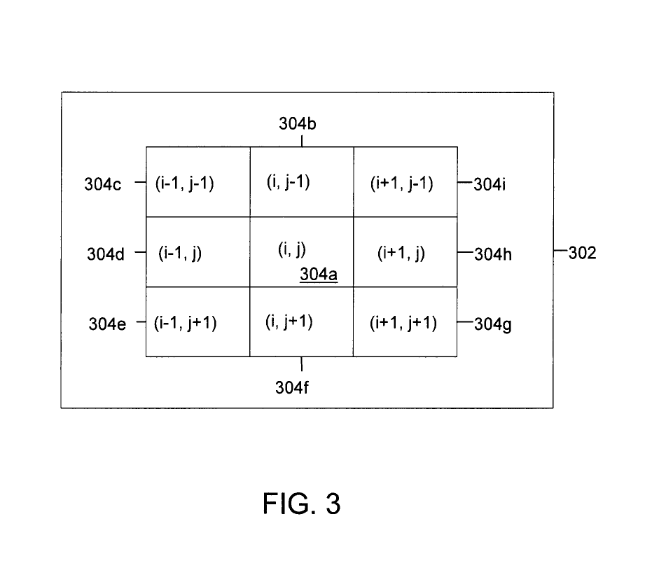

FIG. 3 illustrates a 3×3 neighboring window 302 for classifying a pixel 304a in an image, in accordance with an embodiment of the invention. 3×3 neighboring window 302 is an N×N pixel window, where N may be an odd natural number. The value for N may be selected such that the number of neighboring pixels on each side of pixel 302a is equal. In accordance with an embodiment of the invention, the value of N may be selected to be 3, for 3×3 neighboring window 302, as shown in FIG. 3. 3×3 neighboring window 302 includes pixel 304a to be filtered and one or more neighboring pixels surrounding pixel such as pixels 304b, 304c, 304d, 304e, 304f, 304g, 304h and 304i. The position of pixel 304a and one or more neighboring pixels are depicted using a co-ordinate system. For example, pixel 304a is represented by co-ordinates (i, j). Accordingly, neighboring pixels such as 304b and 304c are represented by (i, j−1) and (i-1,j−1) co-ordinates. Also, pixels such as 304h and 304f are represented by (i+1, j) and (i, j+1). A difference value is calculated for the pixel parameter value of pixel 304a in 3×3 neighboring window 302 is compared with pixel parameter values of one or more neighboring pixels to categorize pixel 302a for filtering the image. The method detailed in FIG. 3 is performed for each of the plurality of pixels of the image for classifying each of the plurality of pixels in corresponding category.

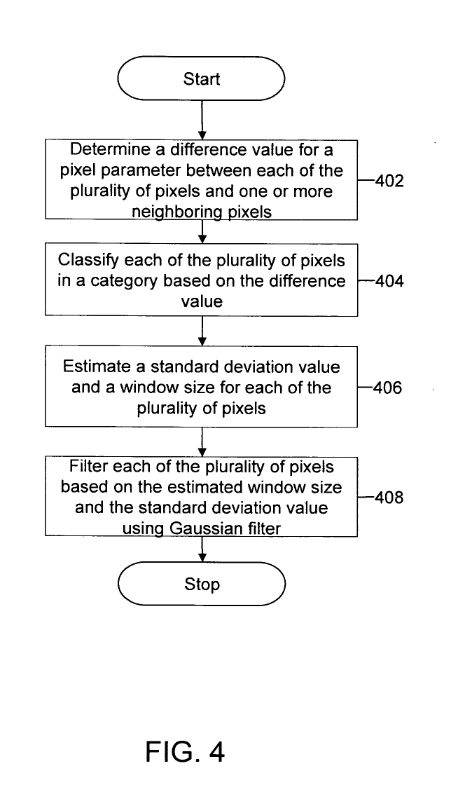

FIG. 4 is a flowchart, illustrating a method for filtering an image, in accordance with an embodiment of the invention. The image includes a plurality of pixels. As explained in FIG. 3, an N×N neighboring window including pixel to be filtered and one or more neighboring pixels is selected. At step 402, a difference value for a pixel parameter between each pixel and one or more neighboring pixels is determined. In an embodiment of the invention, the difference between the pixel luminance and the luminance of one or more neighboring pixels is determined. At step 404, each of the plurality of pixels is classified into a corresponding category based on the calculated difference value. Examples of the category in which each of the plurality of pixels may be classified may include ‘flat’ region pixel category, ‘step-wise’ region pixel category, ‘noise’ region pixel category, ‘edge’ region pixel category and the like. At step 406, a standard deviation value is calculated for each of the plurality of pixels based on the category and a window size is estimated for each of the plurality of pixels. At step 408, each pixel is filtered based on the calculated standard deviation value and the estimated window size.

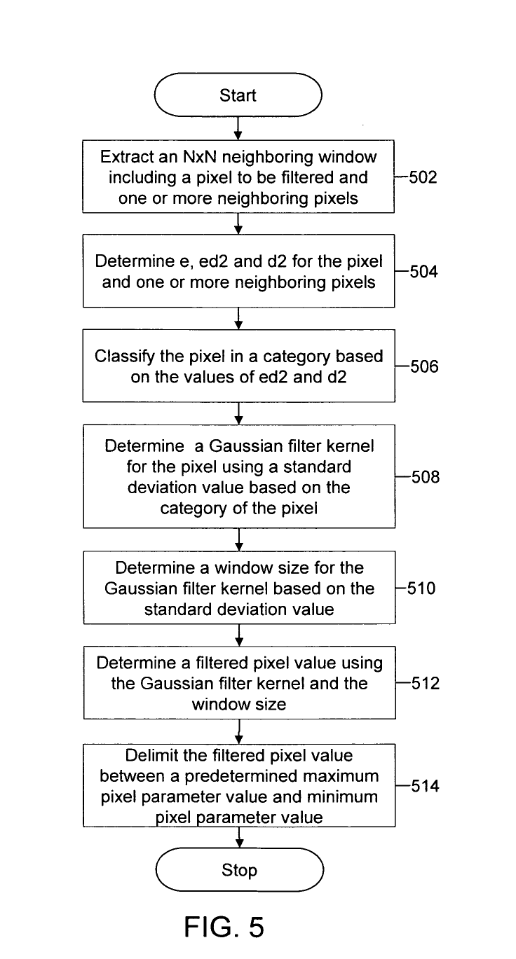

FIG. 5 is a flowchart illustrating a method for filtering each of the plurality of pixels of an image, in accordance with an embodiment of the invention. At step 502, an N×N neighboring window, including the pixel to be filtered and the corresponding one or more neighboring pixels is extracted. At step 504, statistical parameters e, ed2 and d2 are determined for the pixel and one or more neighboring pixels. Statistical parameter ‘e’ represents the average value of a pixel parameter in an extracted neighboring window. Statistical parameter ‘ed2’ represents the average variance of the pixel parameter in the extracted neighboring window. Statistical parameter ‘d2’ represents the difference between the pixel parameter and the average pixel parameter value in the extracted neighboring window. Hence, d2 represents the difference value of the pixel parameter between the pixel and one or more neighboring pixel. For example, the statistical parameters provide the difference between the luminance of the pixel and the luminance of one or more neighboring pixels. The values of e, ed2 and d2 are determined for a 3×3 neighboring window using equations (1), (2) and (3)

$$\begin{matrix}e ( i , j ) = \frac{1}{9} {\sum }_{i = \frac{N - 1}{2}}^{\frac{N - 1}{2}} {\sum }_{j = \frac{N - 1}{2}}^{\frac{N - 1}{2}} I ( m + i , n + j ) & ( 1 ) \\ ed 2 ( i , j ) = \frac{1}{9} {\sum }_{i = \frac{N - 1}{2}}^{\frac{N - 1}{2}} {\sum }_{j = \frac{N - 1}{2}}^{\frac{N - 1}{2}} {( I ( m + i , n + j ) - e ( i , j ) )}^{2} & ( 2 ) \\ d 2 = {( I ( i , j ) - e ( i , j ) )}^{2} & ( 3 )\end{matrix}$$

where I (i, j) is a pixel parameter value for the pixel to be filtered and (i, j) represents the position of the pixel in the window as shown in FIG. 3.

At step 506, the pixel is classified in the category based on the values of ed2 and d2 determined using equation 2 and 3. Thereafter, at step 508, a Gaussian filter kernel for the pixel is determined using a standard deviation value based on the category of the pixel. For example, if the category of the pixel is ‘flat’, the standard deviation is estimated using equation (4)

σ32 1−S1×(ed2+d2) (4)

In the above equation, S1 is a constant determined experimentally. If the category of the pixel is ‘step-wise’, the standard deviation is estimated using equation (5)

σ=1−S2×(ed2+d2) (5)

In the above equation, S2 is a constant determined experimentally.
If the category of the pixel is ‘noise’, the standard deviation is estimated using equation (6)

$$σ = \frac{d 2}{ed 2 + d 2} \qquad ( 6 )$$

If the category of the pixel is ‘edge’, the standard deviation is estimated using equation (7)

$$σ = 0.3 - S 4 \times \frac{ed 2}{ed 2 + d 2} \qquad ( 7 )$$

In the above equation, S4 is a constant determined experimentally.

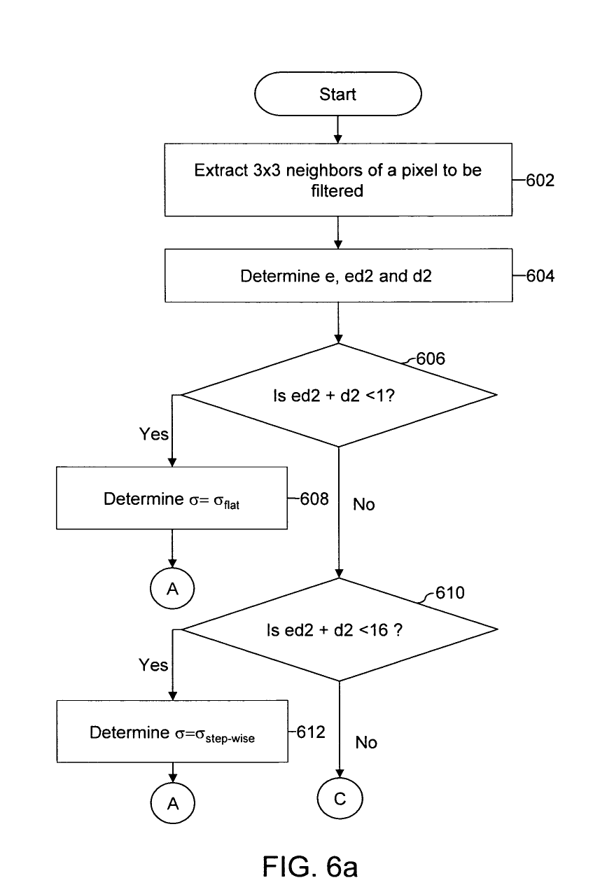

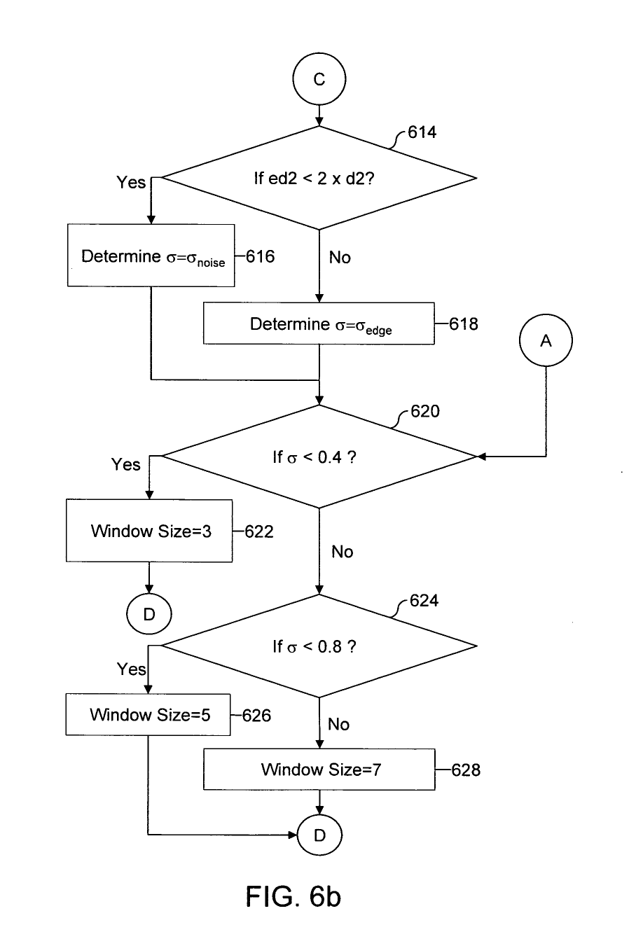

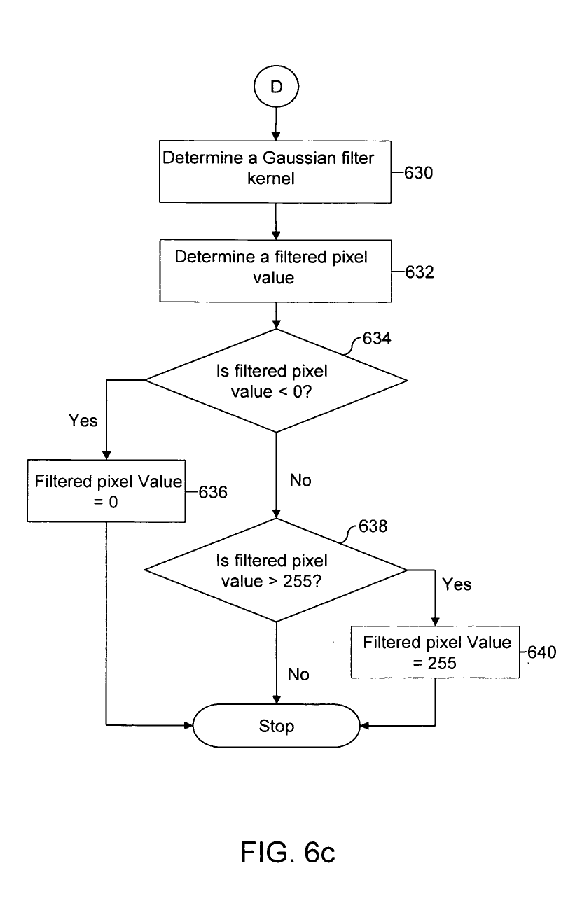

Thereafter, at step 510, a window size for the Gaussian filter kernel is determined based on the standard deviation value. At step 512, a filtered pixel value is determined for the pixel using equation (9) with the Gaussian filter kernel represented by equation (8), and the corresponding window size (WS) determined at step 510.

$$\begin{matrix}g ( i , j ) = \frac{1}{2 πσ} exp ( - ( {i}^{2} + {j}^{2} ) / 2 {σ}^{2} ) & ( 8 ) \\ FI ( i , j ) = {\sum }_{i = - {WS - 1}_{2}}^{{WS - 1}_{2}} {\sum }_{j = - {WS - 1}_{2}}^{{WS - 1}_{2}} g ( m , n ) I ( i - m , j - n ) & ( 9 )\end{matrix}$$

where Fl (i, j) represents filtered image pixel value. At step 514, the filtered pixel value is delimited between a predetermined maximum pixel value and a predetermined minimum pixel parameter. The above method is explained by using an exemplary embodiment of the invention described in conjunction with FIG. 6.

FIGS. 6a, 6b and 6c depict a flowchart, illustrating an embodiment of the method for filtering a pixel of an image in accordance with an embodiment of the invention. At step 602, a 3×3 neighboring including the pixel to be filtered is extracted. At step 604, e, ed2 and d2 are determined using equations (1), (2) and (3). Based on e, ed2 and d2, a category for the pixel is determined. At step 606, the sum of the statistical parameters ed2 and d2 is checked. If the sum of ed2 and d2 is less than one then at step 608, the pixel is classified as a flat region pixel and the standard deviation is calculated using equation (4). If the sum is greater than one, then step 610 is performed. At step 610, it is checked if the sum is less than 16. If the sum is less than 16, then at step 612, the pixel is classified as step-wise pixel and the standard deviation value is calculated using equation (5). If the sum is greater than 16, then at step 614, it is checked whether ed2 is less than twice the value of d2. If ed2 is less than twice the value of d2, the pixel is categorized as noise pixel and the standard deviation value is calculated using equation (6), at step 616. If ed2 is greater than twice the value of d2, then at step 618, the pixel is categorized as edge pixel and the standard deviation is calculated using equation (7).

Thereafter, at step 620, it is checked whether the standard deviation value is less than 0.4. If the value is less than 0.4, at step 622, the window size is estimated to be three. If the standard deviation value is greater than 0.4, then step 624 is performed. At step 624, it is checked whether the standard deviation value is less than 0.8. If the value is less than 0.8, then at step 626 the window size is estimated to be five. If the value is greater than 0.8, then at step 628, the window size is estimated to be seven.

Thereafter, at step 630, Gaussian filter kernel is determined using equation (8). At step 632, a filtered pixel value is estimated using equation (9). Subsequently, at step 634, it is checked whether the filtered pixel value is less than zero. If the filtered pixel value is less than zero, then at step 636, the filtered pixel value is modified to zero. If the filtered pixel value is greater than zero, then at step 638, a check is performed to determine whether the filtered pixel value is greater than 255. If the value is greater than 255, then at step 640, the filtered pixel value is modified to 255. If the filtered pixel value is less than 255 then the filtered pixel value is left unchanged. The modifications of filtered pixel values are represented by equation (10). The method detailed in FIG. 6a, 6b and 6c is performed for each of the pixel of the image to obtain a filtered image.

$$clip ( x ) = \{ \begin{matrix}0 & x < 0 \\ 255 & x > 255 \\ x & else\end{matrix} \qquad ( 10 )$$

The computer program product of the invention is executable on a computer system for causing the computer system to perform a method of filtering an image including an image filtering method of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

Further, the entire system in accordance with the invention may be implemented in a single Field-Programmable Gate Array (FPGA), Digital Signal Processor (DSP) and so forth.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

Furthermore, throughout this specification (including the claims if present), unless the context requires otherwise, the word “comprise”, or variations such as “comprises” or “comprising”, will be understood to imply the inclusion of a stated element or group of elements but not the exclusion of any other element or group of elements. The word “include,” or variations such as “includes” or “including,” will be understood to imply the inclusion of a stated element or group of elements but not the exclusion of any other element or group of elements. Claims that do not contain the terms “means for” and “step for” are not intended to be construed under 35 U.S.C. § 112, paragraph 6.

What is claimed is:

1. A method for filtering an image, the image comprising a plurality of pixels, the method comprising:
a. calculating a difference value for a pixel parameter between each of the plurality of pixels and one or more neighboring pixels associated with each of the plurality of pixels;
b. classifying each of the plurality of pixels in a category based on the difference value;
c. estimating a window size for each of the plurality of pixels based on a standard deviation value for each of the plurality of pixels, wherein the standard deviation value is calculated based on the category; and
d. filtering each of the plurality of pixels based on the estimated window size and the standard deviation value for each of the plurality of the pixels.

2. The method according to claim 1, further comprising calculating a Gaussian filter kernel based on the standard deviation value for each of the plurality of pixels.

3. The method according to claim 1, wherein filtering comprises generating a filtered pixel value based on the standard deviation value and the estimated window size for each of the plurality of pixels.

4. The method according to claim 3, further comprising delimiting the filtered pixel value between a predetermined maximum pixel parameter value and a predetermined minimum pixel parameter value.

5. The method according to claim 1, wherein each of the plurality of pixels is filtered by a Gaussian filter based on the category associated with each of the plurality of pixels.

6. The method according to claim 1, wherein the pixel parameter is luminance of a pixel.

7. A pre-processing filter for filtering an image, the image comprising a plurality of pixels, the pre-processing filter comprising:
a. a difference value calculator, the difference value calculator determining one or more difference values of a pixel parameter, the one or more difference value being determined between each of the plurality of pixels and one or more neighboring pixels;
b. a pixel classifier, the pixel classifier classifying each of the plurality of pixels in a category based on the difference value calculated for each of the plurality of pixels;
c. a standard deviation calculator, the standard deviation calculator calculating a standard deviation value for each of the plurality of pixels based on the category in which each of the plurality of pixels is classified;
d. a window size estimator, the window size estimator estimating a window size for each of the plurality of pixels based on the standard deviation value calculated for each of the plurality of pixels; and
e. a Gaussian filter, the Gaussian filter for filtering each of the plurality of pixels based on the estimated window size and standard deviation value.

8. The pre-processing filter according to claim 7, further comprising a kernel module for calculating a Gaussian filter kernel based on the standard deviation value for each of the plurality of pixels.

9. The pre-processing filter according to claim 7, wherein the Gaussian filter generates a filtered pixel value based on the standard deviation value and the estimated window size for each of the plurality of pixels.

10. The pre-processing filter according to claim 7, further comprising a filter value clipper, the filter value clipper delimiting the filtered pixel value between a predetermined maximum pixel parameter value and a predetermined minimum pixel parameter value.

11. A computer program product for filtering an image, the image comprising a plurality of pixels, the computer program product comprising:
a. program instruction means for calculating a difference value for a pixel parameter between each of the plurality of pixels and one or more neighboring pixels associated with each of the plurality of pixels;
b. program instruction means for classifying each of the plurality of pixels in a category based on the difference value;
c. program instruction means for estimating a window size for each of the plurality of pixels based on a standard deviation value, wherein the standard deviation value is calculated based on the category; and
d. program instruction means for filtering each of the plurality of pixels based on the estimated window size and the standard deviation value for each of the plurality of pixels.

12. The computer program product according to claim 11, further comprising program instruction means for calculating a Gaussian filter kernel based on the standard deviation value for each of the plurality of pixels.

13. The computer program product according to claim 11, wherein the program instruction means for filtering further comprises program instruction means for generating a filtered pixel value based on the calculated standard deviation and the estimated window size for each of the plurality of pixels.

14. The computer program product according to claim 13, further comprising program instruction program instruction means for delimiting the filtered pixel value between a predetermined maximum pixel parameter value and a predetermined minimum pixel parameter value.

15. The computer program product according to claim 11, wherein the program instruction means for filtering further comprises program instruction means for filtering each of the plurality of pixels by a Gaussian filter based on the category associated with each of the plurality of pixels.
